(19) United States
(12) Patent Application Publication
(10) Pub. No.: US 2015/0324850 A1
(43) Pub. Date: Nov. 12, 2015

(54) SYSTEM AND METHOD FOR AUTOMATICALLY PROVIDING VIRTUAL CUSTOMER-PERSONALIZED CONTENT IN A RETAIL COMMERCE ENVIRONMENT

(71) Applicant: VERIFONE, INC., San Jose, CA (US)

(72) Inventor: Hugo Marquez RIVERA, Huixquilucan (MX)

(73) Assignee: VERIFONE, INC., San Jose, CA (US)

(21) Appl. No.: 14/271,986

(22) Filed: May 7, 2014

(51) Int. Cl. G06Q 30/02; G06Q 50/00

(52) U.S. Cl. CPC G06Q 30/0261; G06Q 30/0267; G06Q 30/0269; G06Q 50/01; G06Q 30/0268

(57) ABSTRACT

A method and system for automatically providing virtual customer-personalized content in a retail commerce environment, the method and system enabling a customer to receive a physical transaction-related article including at least computer-readable transaction-derived data which may or may not relate to a transaction of the customer in the retail commerce environment, at least part of the computer-readable transaction-derived data on the physical transaction-related article being scannable, by the customer and automatically employing the at least part of the computer-readable transaction-derived data to automatically provide virtual customer-personalized content corresponding to at least part of the at least part of the computer-readable transaction-derived data.

### FIELD OF THE INVENTION

The present invention relates generally to systems and methods for automatically providing virtual customer-personalized content in a retail commerce environment.

### BACKGROUND OF THE INVENTION

Systems and methods for automatically providing customer-personalized offers in a retail commerce environment are known.

### SUMMARY OF THE INVENTION

The present invention seeks to provide a system and method for automatically providing virtual customer-personalized content in a retail commerce environment.

There is thus provided in accordance with a preferred embodiment of the present invention a method for automatically providing virtual customer-personalized content in a retail commerce environment, the method including enabling a customer to receive a physical transaction-related article including at least computer-readable transaction-derived data relating to a transaction of the customer in the retail commerce environment, at least part of the computer-readable transaction-derived data on the physical transaction-related article being scannable, by the customer, into a computing device, and automatically employing the at least part of the computer-readable transaction-derived data to automatically provide, to the computing device, virtual customer-personalized content corresponding to at least part of the at least part of the computer-readable transaction-derived data.

Preferably, the method also includes communicating via the internet and retrieving personal information pertaining to the customer by accessing at least one personal profile of the customer from at least one internet-based social network. Preferably, the method also includes employing the personal information to generate the virtual customer-personalized content.

Preferably, the physical transaction-related article is a paper transaction receipt of the transaction. Additionally or alternatively, the computer-readable transaction-derived data is a QR code including at least data related to the transaction. Additionally or alternatively, the computer-readable transaction-derived data includes text including at least data related to the transaction. Additionally or alternatively, the computer-readable transaction-derived data includes at least one image including at least data related to the transaction.

Preferably, the text includes a list of items purchased by the customer in the transaction. Preferably, the at least one image includes at least one image of at least one item purchased by the customer in the transaction.

Preferably, the physical transaction-related article is provided by a POS system associated with the retail commerce environment.

In accordance with a preferred embodiment of the present invention, the method also includes at least one of analyzing transactions made at the retail commerce environment to ascertain customer purchasing patterns of the customer, retrieving existing customer purchasing pattern information of the customer from a computer network serving the retail commerce environment and communicating via the internet and retrieving personal information pertaining to the customer by accessing at least one personal profile of the customer from at least one internet-based social network. Preferably, the method also includes at least one of employing at least some of the personal information, the transaction information and the purchasing patterns of the customer to generate customer-personalized promotional offers, and retrieving existing customer-personalized promotional offers from a computer network serving the retail commerce environment. Preferably, the method also includes generating virtual customer-personalized content corresponding to the customer-personalized promotional offers. Preferably, the method also includes displaying the virtual customer-personalized content on the computing device.

Preferably, the computing device is one of a handheld computing device and a mobile smartphone. Preferably, the virtual customer-personalized content is overlaid onto the at least part of the computer-readable transaction-derived data scanned into the computing device.

Preferably, the virtual customer-personalized content includes at least text. Additionally or alternatively, the virtual customer-personalized content includes at least a graphic image. Additionally or alternatively, the virtual customer-personalized content includes at least an animation.

In accordance with a preferred embodiment of the present invention, the virtual customer-personalized content is also transaction-related.

There is also provided in accordance with another preferred embodiment of the present invention a system for automatically providing virtual customer-personalized content in a retail commerce environment, the system including physical transaction-related article providing functionality operative to provide, to a customer, a physical transaction-related article including at least computer-readable transaction-derived data relating to a transaction of the customer in the retail commerce environment, automatic virtual customer-personalized content providing functionality operative, responsive to scanning at least part of the computer-readable transaction-derived data into a computing device communicating with the automatic virtual customer-personalized content providing functionality, to receive the at least part of the computer-readable transaction-derived data, and to automatically employ the at least part of the computer-readable transaction-derived data to automatically provide, to the computing device, virtual customer-personalized content corresponding to at least part of the at least part of the computer-readable transaction-derived data.

Preferably, the automatic virtual customer-personalized content providing functionality is also operable for communicating via the internet and for retrieving personal information pertaining to the customer by accessing at least one personal profile of the customer from at least one internet-based social network. Preferably, the automatic virtual customer-personalized content providing functionality is also operable for employing the personal information to generate the virtual customer-personalized content.

Preferably, the physical transaction-related article is a paper transaction receipt of the transaction. Additionally or alternatively, the computer-readable transaction-derived data is a QR code including at least data related to the transaction. Additionally or alternatively, the computer-readable transaction-derived data includes text including at least data related to the transaction. Additionally or alternatively, the computer-readable transaction-derived data includes at least one image including at least data related to the transaction.

Preferably, the text includes a list of items purchased by the customer in the transaction. Preferably, the at least one image includes at least one image of at least one item purchased by the customer in the transaction.

Preferably, the physical transaction-related article providing functionality resides on a POS system associated with the retail commerce environment.

Preferably, the automatic virtual customer-personalized content providing functionality resides on a computer server. Preferably, the server resides on the premises of the retail commerce environment. Alternatively, the server does not reside on the premises of the retail commerce environment. Yet alternatively, the server resides in a network cloud connected to the internet.

Preferably, the automatic virtual customer-personalized content providing functionality is also operative to access at least information regarding transactions made by the customer at the retail commerce environment. Preferably, the transaction information is stored on a computer network serving the retail commerce environment. Preferably, the automatic virtual customer-personalized content providing functionality is also operative to access at least personal information of the customer. Preferably, the personal information is stored on a computer network serving the retail commerce environment. Preferably, the personal information includes at least one of a name, a personal identification number and credit card information.

In accordance with a preferred embodiment of the present invention, the automatic virtual customer-personalized content providing functionality is also operable for at least one of analyzing transactions made at the retail commerce environment to ascertain customer purchasing patterns of the customer, retrieving customer purchasing pattern information of the customer from a computer network serving the retail commerce environment, communicating via the internet and retrieving personal information pertaining to the customer by accessing at least one personal profile of the customer from at least one internet-based social network. Preferably, the automatic virtual customer-personalized content providing functionality is also operable for at least one of employing at least some of the personal information, the transaction information and the purchasing patterns of the customer to generate customer-personalized promotional offers, and retrieving customer-personalized promotional offers from a computer network serving the retail commerce environment. Preferably, the automatic virtual customer-personalized content providing functionality is also operative to generate virtual customer-personalized content corresponding to the customer-personalized promotional offers.

Preferably, the virtual customer-personalized content is displayed on the computing device. Preferably, the computing device is one of a handheld computing device and a mobile smartphone.

Preferably, the virtual customer-personalized content is overlaid onto the at least part of the computer-readable transaction-derived data scanned into the computing device. Preferably, the virtual customer-personalized content includes at least text. Additionally or alternatively, the virtual customer-personalized content includes at least a graphic image. Additionally or alternatively, the virtual customer-personalized content includes at least an animation.

Preferably, the virtual customer-personalized content is also transaction-related.

There is further provided in accordance with yet another preferred embodiment of the present invention a method for automatically providing virtual customer-personalized content in a retail commerce environment, the method including providing, to a customer, a physical transaction-related article including at least computer-readable transaction-derived data relating to a transaction of the customer in the retail commerce environment, scanning, by the customer, at least part of the computer-readable transaction-derived data into a computing device, and automatically employing the at least part of the computer-readable transaction-derived data to automatically provide, to the computing device, virtual customer-personalized content corresponding to at least part of the at least part of the computer-readable transaction-derived data.

There is yet further provided in accordance with still another preferred embodiment of the present invention a system for automatically providing virtual customer-personalized content in a retail commerce environment, the system including automatic virtual customer-personalized content providing functionality operative, responsive to scanning computer-readable transaction-derived data provided to a customer into a computing device communicating with the automatic virtual customer-personalized content providing functionality, to receive the at least part of the computer-readable transaction-derived data, and to automatically employ the computer-readable transaction-derived data to automatically provide, to the computing device, virtual customer-personalized content corresponding to at least part of the computer-readable transaction-derived data.

### BRIEF DESCRIPTION OF THE DRAWINGS

The present invention will be understood and appreciated more fully from the following detailed description, taken in conjunction with the drawings in which:

FIG. 1A is a simplified pictorial illustration of one example of the operation of a system for automatically providing virtual customer-personalized augmented reality content in a retail commerce environment, in accordance with a preferred embodiment of the present invention;

FIG. 1B is a simplified pictorial illustration of another example of the operation of a system for automatically providing virtual customer-personalized content in a retail commerce environment, in accordance with a preferred embodiment of the present invention;

FIG. 1C is a simplified pictorial illustration of a further example of the operation of a system for automatically providing virtual customer-personalized content in a retail commerce environment, in accordance with a preferred embodiment of the present invention;

FIG. 2 is a simplified flowchart indicating steps in the operation of the system of FIGS. 1A-1C; and

FIG. 3 is a simplified block diagram illustration of a system, constructed and operative in accordance with a preferred embodiment of the present invention, for automatically providing virtual customer-personalized content in a retail commerce environment, examples of whose operation are shown in FIGS. 1A-1C.

### DETAILED DESCRIPTION OF PREFERRED EMBODIMENTS

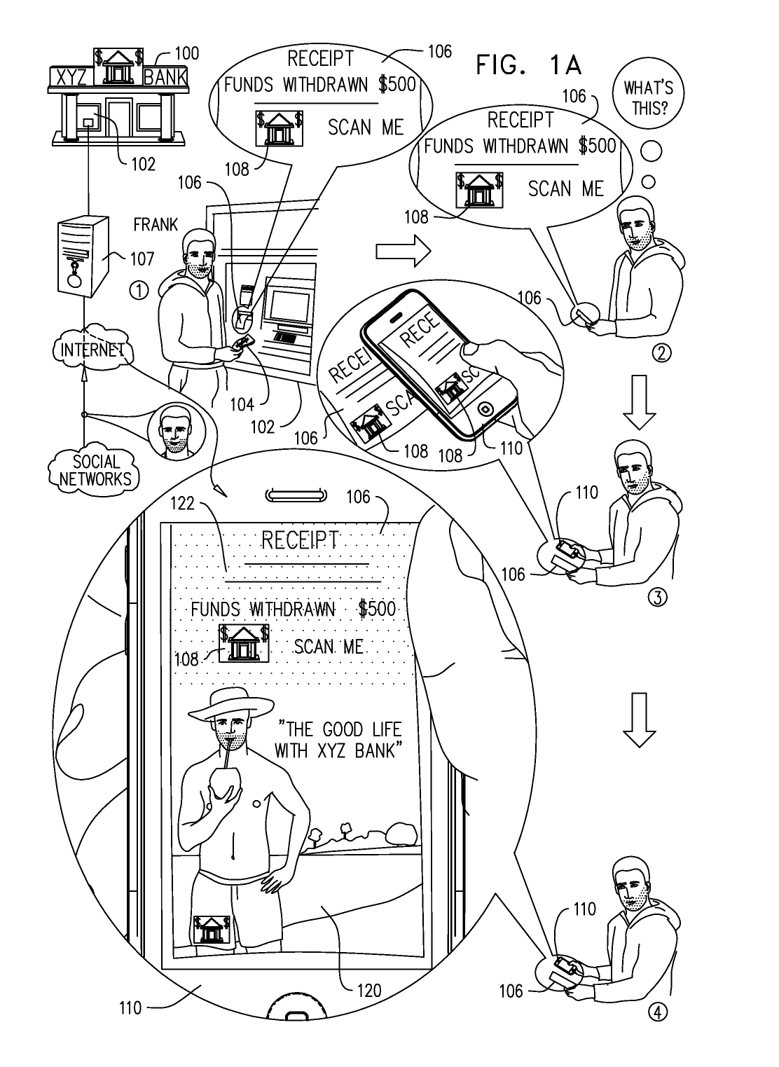

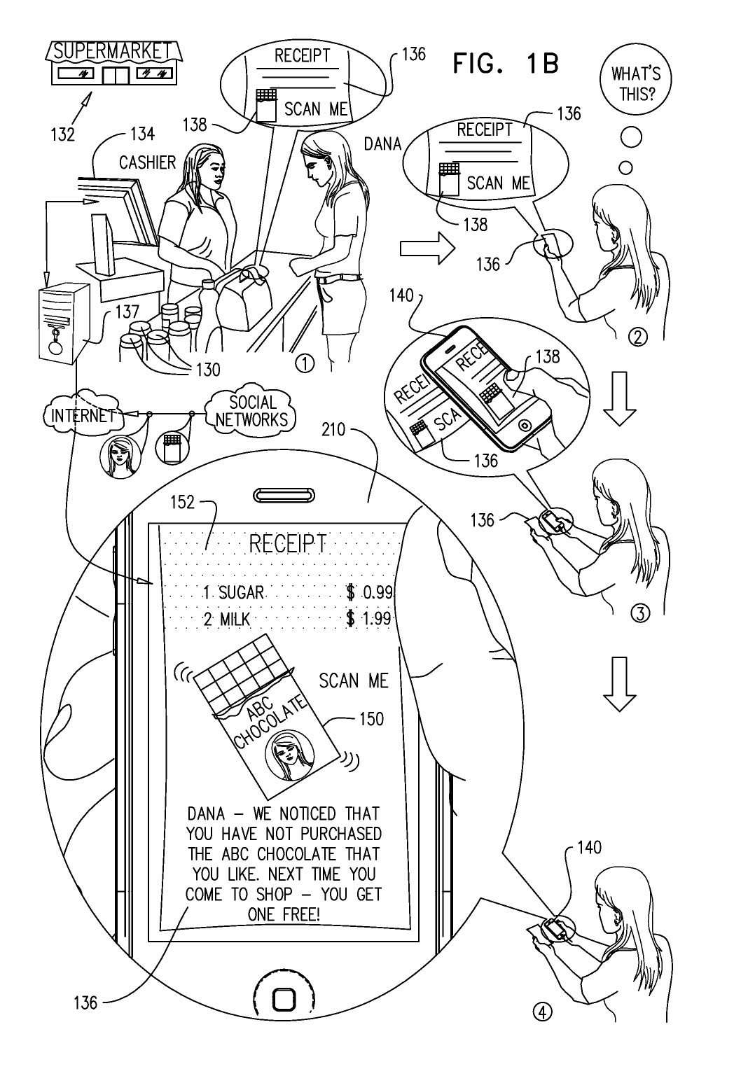

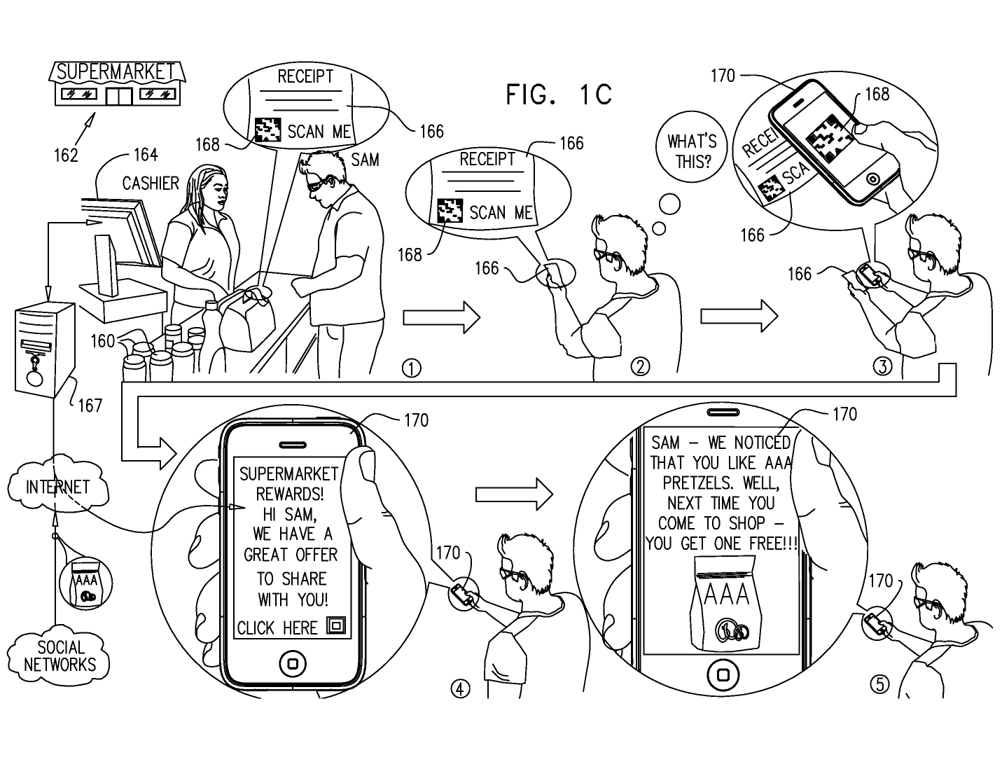

Reference is now made to FIG. 1A, which is a simplified pictorial illustration of one example of the operation of a system for automatically providing virtual customer-personalized augmented reality content in a retail commerce environment, in accordance with a preferred embodiment of the present invention. The system illustrated in FIG. 1A is preferably operable for:

enabling a customer to receive a physical transaction-related article comprising at least computer-readable transaction-derived data relating to a transaction of said customer in the retail commerce environment, at least part of the computer-readable transaction-derived data on the physical transaction-related article being scannable, by the customer; and

automatically employing at least part of the computer-readable transaction-derived data to automatically provide virtual customer-personalized augmented reality content corresponding to at least part of the computer-readable transaction-derived data.

Preferably the scanning and the display of the augmented reality content is provided on a single computing device, such as a smart phone, GOOGLE® GLASS™, IPAD® or tablet. Alternatively, the scanning and the display may be on separate devices.

The foregoing functionality may also be understood as:

providing, to a customer, a physical transaction-related article including at least computer-readable transaction-derived data relating to a transaction of the customer in the retail commerce environment;

optically scanning at least part of the computer-readable transaction-derived data; and

automatically employing the at least part of the computer-readable transaction-derived data to automatically provide, to the customer, virtual customer-personalized augmented reality content corresponding to the at least part of the computer-readable transaction-derived data.

The system is also preferably operable for communicating via the internet and retrieving personal information pertaining to the customer by accessing at least one personal profile of the customer from at least one internet-based social network, and employing the personal information to generate the virtual customer-personalized content. Alternatively or additionally, the system may provide content to one or more social networks.

It is appreciated that the retail commerce environment in which the present invention is operable may include any suitable retail commerce environment, for example, a store, a bank, an airport check in counter or kiosk, a rental facility such as a car rental agency, a ticket agency, an automated vending machine and any other environment wherein a customer executes a purchase or a business transaction.

As shown in step 1 of the example of FIG. 1A, Frank, a customer of the XYZ bank 100, employs an ATM machine 102 to withdraw cash 104 from his account. As further shown in FIG. 1A, ATM 102 preferably issues a transaction receipt 106 to Frank.

It is appreciated that ATM 102 preferably communicates, inter alia, with a server 107, server 107 being operative to store and access personal information of the customers of bank 100 as well as information regarding transactions made by customers of bank 100. The personal information may include, for example, a name, a personal identification number and account information. The personal information and transaction information are typically gathered by and stored on computer servers which are part of a computer network serving bank 100.

As shown in FIG. 1A, server 107 typically resides on the premises of bank 100, however server 107 may alternatively be located at a location central to a plurality of branches of bank 100 or in a network cloud connected to the internet.

It is further appreciated that server 107 is preferably operative to analyze transactions made at bank 100 and to ascertain banking and purchasing patterns and behavior of customers of bank 100. Alternatively, server 107 may be operable to access customer banking and purchasing pattern information from computer servers which are part of a computer network serving bank 100.

It is a particular feature of an embodiment of the present invention that server 107 may be connected to the internet and may retrieve additional personal information pertaining to customers of bank 100 by accessing personal profiles of customers of bank 100, which personal profiles are publicly available, for example, on internet-based social networks. Server 107 may analyze information received from the internet to derive conclusions regarding preferences of a customer and to employ those conclusions in preparing the content which is supplied to the customer.

It is a further particular feature of an embodiment of the present invention that server 107 is further operative to generate and to provide to a customer, virtual content which is customer-personalized and may or may not be transaction-related. Such virtual customer-personalized content may include, for example, text, images and animations. Such virtual customer-personalized content may also include or be based on, for example, personal characteristics of the customer as retrieved from a personal profile of the customer on an internet-based social network such as, for example, a name, photographs, hobbies of the customer, and various other personal preferences or characteristics. As shown in the example of FIG. 1A, server 107 accesses a personal profile of Frank and retrieves a photograph of Frank from the social network.

The virtual customer-personalized content may be, for example, of an entertaining nature, featuring personal characteristics of the customer or of his banking or purchasing habits. The virtual customer-personalized content is preferably suitable for display on computerized display systems, such as on a desktop computer, a handheld computing device and a mobile smartphone. Preferably, the virtual customer-personalized content is presented in the form of augmented reality.

Additionally or alternatively, by employing personal information, transaction information and banking and purchasing patterns of customers of bank 100, server 107 may be operative to generate promotional offers, such as coupons, which are customer-personalized and may or may not be transaction-related. Yet, alternatively, server 107 may be operative to access pre-generated promotional offers which are customer-personalized from computer servers which are part of a computer network serving bank 100. In turn, server 107 is preferably further operative to generate virtual customer-personalized content corresponding to the promotional offers. Alternatively or additionally, the system may provide virtual customer-personalized content, for example, text, images, animations, promotional offers and coupons to one or more social networks.

It is yet a further particular feature of an embodiment of the present invention that transaction receipt 106 includes computer-readable transaction-derived data relating to Frank's withdrawal. In the example of FIG. 1A, the computer-readable data includes a graphic logo 108 of bank 100 printed on transaction receipt 106. It is appreciated that the computer-readable transaction-derived data of transaction receipt 106 may additionally or alternatively include, for example, an account summary of Frank's account and a list of recent bank transactions executed by Frank at bank 100.

Logo 108 is preferably designed for computerized scanning onto a suitable computing device equipped with optical scanning functionality and suitable graphic image processing functionality. Suitable computing devices include, for example, mobile smartphones, GOOGLE® GLASS™, IPAD®, handheld computing devices and tablet computers including an integrated camera and graphic image processing functionality associated therewith.

It is appreciated that optical scanning functionality is typically preinstalled on mobile smartphones having a camera integrated therewith, or may be downloaded by the user of a mobile smartphone from an online distribution platform associated with the mobile smartphone or with the mobile service provider of the mobile smartphone, such as an appstore. The optical scanning functionality is typically operative to analyze graphic images and to retrieve information encoded therewithin. Alternatively, the optical scanning functionality may be separate from a computing device.

It is further appreciated that logo 108 may be recognizable by the optical scanning functionality as being associated, for example, with a URL address which references a web site of a business associated with logo 108, or with a mobile smartphone application installed on the mobile smartphone and associated with a business associated with logo 108. It is appreciated that in a case where the mobile smartphone application is not installed on the mobile smartphone, a user of the mobile smartphone may be prompted to install the mobile smartphone application on the mobile smartphone upon scanning of the logo. Similarly, in a case where the mobile smartphone is not connected to the internet, a user of the mobile smartphone may be prompted to connect to the internet.

As shown in step 2 of the example of FIG. 1A, Frank notices logo 108 printed on transaction receipt 106, and as shown thereafter in step 3 of the example of FIG. 1A, Frank employs optical scanning functionality installed on a mobile smartphone 110 and associated with a camera integrated therewith, to scan logo 108 into mobile smartphone 110. Scanned logo 108 is then preferably fed to an application associated with bank 100 and which is preferably preinstalled on mobile smartphone 110, the application preferably having access to Frank's identity.

It is a particular feature of the present invention that the bank application preferably communicates with server 107, such as via the internet, and retrieves therefrom virtual customer-personalized content designated for Frank. In the example of FIG. 1A, server 107 preferably accesses personal information pertaining to Frank by accessing Frank's personal profile on an internet-based social network, and employs the personal information to generate the virtual customer-personalized content.

As shown in step 4 of the example of FIG. 1A, upon scanning logo 108 into mobile smartphone 110, the bank application is invoked and communicates Frank's identity to server 107. Responsive to receiving identity information relating to Frank, server 107 transmits virtual content of an entertaining nature for display on mobile smartphone 110. The virtual content preferably comprises an augmented reality presentation including an animation of Frank which includes his photo as retrieved by server 107 from a social network, and promotional content relating to bank 100, for display on mobile smartphone 110. The augmented reality presentation, here designated by reference numeral 120, is preferably overlaid over the transaction receipt, here designated by reference numeral 122. Alternatively the virtual content may be displayed on any other suitable device, which may or may not be a computing device. It is appreciated that the virtual content may also include an interactive feature such as a request for customer feedback or a customer satisfaction survey.

Reference is now made to FIG. 1B, which is a simplified pictorial illustration of another example of the operation of a system for automatically providing virtual customer-personalized augmented reality content in a retail commerce environment, in accordance with a preferred embodiment of the present invention.

As shown in step 1 of the example of FIG. 1B, a customer, Dana, purchases a multiplicity of groceries 130 at supermarket 132. As further shown in FIG. 1B, a cashier typically employs a Point of Sale (POS) system 134 to process the purchase by calculating an amount owed by the customer in return for groceries 130, accepting payment from the customer, and issuing a transaction receipt 136 to the customer. It is appreciated that POS system 134 may include hardware and software components such as, for example, weighing scales, scanners, electronic and manual cash registers, EFTPOS terminals and touch screens.

It is further appreciated that POS 134 preferably communicates, inter alia, with a server 137, server 137 being operative to store and access personal information of the customers of supermarket 132 as well as information regarding transactions made by customers at supermarket 132. The personal information may include, for example, a name, a personal identification number and credit card information. The personal information and transaction information are typically gathered by and stored on computer servers which are part of a computer network serving supermarket 132.

As shown in FIG. 1B, server 137 typically resides on the premises of supermarket 132, however server 137 may alternatively be located at a location central to a chain of supermarkets with which supermarket 132 is associated or in a network cloud connected to the internet.

It is further appreciated that server 137 is preferably operative to analyze transactions made at supermarket 132 and to ascertain purchasing patterns of customers of supermarket 132. Alternatively, server 137 may be operable to access customer purchasing pattern information from computer servers which are part of a computer network serving supermarket 132.

It is a particular feature of an embodiment of the present invention that server 137 may be connected to the internet and may retrieve additional personal information pertaining to customers of supermarket 132 by accessing personal profiles of customers of supermarket 132, which personal profiles are publicly available, for example, on internet-based social networks. Alternatively or additionally, the system may provide virtual customer-personalized content, for example, text, images, animations, promotional offers and coupons to one or more social networks.

It is a further particular feature of an embodiment of the present invention that server 137 is further operative to generate and to provide to a customer, virtual content which is customer-personalized and may or may not be transaction-related. Such virtual customer-personalized content may include, for example, text, images and animations. Such virtual customer-personalized content may also include or be based on, for example, personal characteristics of the customer as retrieved from a personal profile of the customer on an internet-based social network such as, for example, a name, photographs, hobbies of the customer, and various other personal preferences or characteristics. As shown in the example of FIG. 1B, server 137 accesses a personal profile of Dana which is publicly available on a social network, and discovers that Dana is fond of a particular brand of chocolate and retrieves a photograph of a package of the chocolate. As further shown in the example of FIG. 1B, server 137 also retrieves a photograph of Dana from the social network.

The virtual customer-personalized content may be, for example, of an entertaining nature, featuring personal characteristics of the customer or of her purchasing habits. The virtual customer-personalized content is preferably suitable for display on computerized display systems, such as on a desktop computer, a handheld computing device and a mobile smartphone. Preferably, the virtual customer-personalized content is presented in the form of augmented reality.

Additionally or alternatively, by employing personal information, transaction information and purchasing patterns of customers of supermarket 132, server 137 is preferably operative to generate promotional offers which are customer-personalized and may or may not be transaction-related. Yet alternatively, server 137 may be operable to access pre-generated promotional offers which are customer-personalized from computer servers which are part of a computer network serving supermarket 132. In turn, server 137 is preferably further operative to generate virtual customer-personalized content corresponding to the customer-personalized promotional offers.

It is a further particular feature of an embodiment of the present invention that transaction receipt 136 includes computer-readable transaction-derived data relating to Dana's purchase. In the example of FIG. 1B, the computer-readable transaction-derived data printed on transaction receipt 136 includes a graphic image 138 of the particular brand of chocolate which Dana is fond of. It is appreciated that the computer-readable transaction-derived data of transaction receipt 136 may additionally or alternatively include, for example, a list of groceries 130 purchased by Dana, a price associated with each of groceries 130, one or more images of groceries 130 purchased by Dana and one or more images associated with supermarket 132.

Image 138 is preferably designed for computerized scanning onto a suitable computing device equipped with optical scanning functionality and suitable graphic image processing functionality. Suitable computing devices include, for example, mobile smartphones, handheld computing devices and tablet computers including an integrated camera and graphic image processing functionality associated therewith.

It is appreciated that optical scanning functionality is typically preinstalled on mobile smartphones having a camera integrated therewith, or may be downloaded by the user of a mobile smartphone from an online distribution platform associated with the mobile smartphone or with the mobile service provider of the mobile smartphone, such as an appstore. The optical scanning functionality is typically operative to analyze graphic images and to retrieve information encoded therewithin.

It is further appreciated that image 138 may be recognizable by the optical scanning functionality as being associated, for example, with a URL address which references a web site of a business associated with image 138, or with a mobile smartphone application installed on the mobile smartphone and associated with a business associated with image 138. It is appreciated that in a case where the mobile smartphone application is not installed on the mobile smartphone, a user of the mobile smartphone may be prompted to install the mobile smartphone application on the mobile smartphone upon scanning of the logo.

As shown in step 2 of the example of FIG. 1B, Dana notices image 138 printed on transaction receipt 136, and as shown thereafter in step 3 of the example of FIG. 1B, Dana employs optical scanning functionality installed on a mobile smartphone 140 and associated with a camera integrated therewith, to scan image 138 into mobile smartphone 140. Scanned image 138 is then preferably fed to an application associated with supermarket 132 and preferably preinstalled on mobile smartphone 140, the application preferably having access to Dana's identity.

As described hereinabove, it is a particular feature of the present invention that the supermarket application preferably communicates with server 137, such as via the internet, and retrieves therefrom virtual customer-personalized content designated for Dana. In the example of FIG. 1B, server 137 preferably accesses personal information pertaining to Dana by accessing Dana's personal profile on an internet-based social network, and employs the personal information to generate the virtual customer-personalized content.

It is a particular feature of the present invention that server 137 preferably employs transaction-derived data relating to Dana's purchase to generate virtual customer-personalized content corresponding to promotional offers which are related to Dana's recent purchase. In the example of FIG. 1B, server 137 ascertains that in her recent purchase, Dana has not purchased the particular brand of chocolate that she is fond of, as discovered by server 137 by accessing Dana's personal profile on the social network.

As shown in step 4 of the example of FIG. 1B, upon scanning image 138 into mobile smartphone 140, the supermarket application is invoked and preferably communicates Dana's identity to server 137. Responsive to receiving identity information relating to Dana, server 137 transmits virtual customer-personalized content comprising an animated promotional offer for the chocolate that Dana is fond of, to be displayed on mobile smartphone 140 and addressed to Dana.

As further shown in step 4 of FIG. 1B, the animated promotional offer is displayed to Dana on the screen of mobile smartphone 140. As clearly shown, the animated promotional offer is overlaid over the image of transaction receipt 136 as scanned by Dana, preferably employing augmented reality functionality to highlight and animate a package of the particular brand of chocolate which Dana is fond of, and to offer her the item free of charge upon her next purchase. The augmented reality animation, here designated by reference numeral 150, is preferably overlaid over the transaction receipt, here designated by reference numeral 152 and may include Dana's photograph 154 or an image derived therefrom. Alternatively the virtual content may be displayed on any other suitable device, which may or may not be a computing device. It is appreciated that the virtual content may also include an interactive feature such as a request for customer feedback or a customer satisfaction survey.

Reference is now made to FIG. 1C, which is a simplified pictorial illustration of a further example of the operation of a system for automatically providing virtual customer-personalized content in a retail commerce environment, in accordance with a preferred embodiment of the present invention.

As shown in step 1 of the example of FIG. 1C, a customer, Sam, purchases a multiplicity of groceries 160 at supermarket 162. As further shown in FIG. 1C, and as described hereinabove with regard to FIG. 1B, a cashier typically employs Point of Sale (POS) system 164 to process the purchase by calculating an amount owed by the customer in return for groceries 160, accepting payment from the customer, and issuing a transaction receipt 166 to the customer. As further described hereinabove with regard to FIG. 1B, it is appreciated that POS system 164 may include hardware and software components such as, for example, weighing scales, scanners, electronic and manual cash registers, EFTPOS terminals and touch screens.

As yet further described hereinabove with regard to FIG. 1B, it is further appreciated that POS 164 preferably communicates with a server 167, server 167 being operative to store and access personal information of the customers of supermarket 162 as well as information regarding transactions made by customers at supermarket 162. The personal information may include, for example, a name, a personal identification number and credit card information. The personal information and transaction information are typically gathered by and stored on computer servers, which are part of a computer network serving supermarket 162.

As shown in FIG. 1C, server 167 typically resides on the premises of supermarket 162, however server 167 may alternatively be located at a location central to a chain of supermarkets with which supermarket 162 is associated or in a network cloud connected to the internet.

It is further appreciated that server 167 is preferably operative to analyze transactions made at supermarket 162 and to ascertain purchasing patterns of customers of supermarket 162. Alternatively, server 167 may be operable to access customer purchasing pattern information from computer servers which are part of a computer network serving supermarket 162.

It is a particular feature of an embodiment of the present invention that server 167 may be connected to the internet and may retrieve additional personal information pertaining to customers of supermarket 162 by accessing personal profiles of customers of supermarket 162 publicly available, for example, on internet-based social networks. Alternatively or additionally, the system may provide virtual customer-personalized content, for example, text, images, animations, promotional offers and coupons to one or more social networks.

It is a further particular feature of an embodiment of the present invention that server 167 is further operative to generate and to provide to a customer, virtual content which is customer-personalized and may or may not be transaction-related. Such virtual customer-personalized content may include, for example, text, images and animations. Such virtual customer-personalized content may also include or be based on, for example, personal characteristics of the customer as retrieved from a personal profile of the customer on an internet-based social network such as, for example, a name, a photograph, hobbies of the customer, and various personal preferences or characteristics. As shown in the example of FIG. 1C, server 167 accesses a personal profile of Sam which is publicly available on a social network, discovers that Sam is fond of a particular brand of pretzels, and retrieves a photograph of a package of the pretzels.

The virtual customer-personalized content may be, for example, of an entertaining nature, featuring personal characteristics of the customer or of his purchasing habits. The virtual customer-personalized content is preferably suitable for display on computerized display systems, such as on a desktop computer, a handheld computing device and a mobile smartphone.

Additionally or alternatively, by employing personal information, transaction information and purchasing patterns of customers of supermarket 162, server 167 is preferably operative to generate promotional offers, such as coupons, which are customer-personalized and may or may not be transaction-related. Yet, alternatively, server 167 may be operable to access pre-generated promotional offers which are customer-personalized from computer servers which are part of a computer network serving supermarket 162. In turn, server 167 is preferably further operative to generate virtual customer-personalized content corresponding to the customer-personalized promotional offers.

It is a further particular feature of an embodiment of present invention that transaction receipt 166 includes computer-readable transaction-derived data relating to Sam's purchase. In the example of FIG. 1C, the computer-readable transaction-derived data includes a QR code 168 printed on transaction receipt 166. It is appreciated that the computer-readable transaction-derived data of transaction receipt 166 may additionally or alternatively include, for example, a list of groceries 160 purchased by Sam, a price associated with each of groceries 160, one or more images of groceries 160 purchased by Sam and one or more images associated with supermarket 162.

QR code 168 is preferably designed for computerized scanning onto a suitable computing device equipped with optical scanning functionality and suitable QR code reading functionality. Suitable computing devices include, for example, mobile smartphones, handheld computing devices and tablet computers including an integrated camera and QR code reading functionality associated therewith.

It is appreciated that QR code reading functionality is typically downloaded by the user of a mobile smartphone from an online distribution platform associated with the mobile smartphone or with the mobile service provider of the mobile smartphone, such as an appstore. The QR code reading functionality is typically operative to decode QR codes and to retrieve the information encoded therewithin.

It is further appreciated that information encoded in a QR code may include, for example, a URL address which references a web site, or a reference to a mobile smartphone application installed on the mobile smartphone. It is appreciated that in a case where a QR code references a mobile smartphone application which is not installed on the mobile smartphone, a user of the mobile smartphone may be prompted to install the mobile smartphone application on the mobile smartphone upon scanning of the QR code.

As shown in step 2 of the example of FIG. 1C, Sam notices QR code 168 printed on transaction receipt 166, and, as shown thereafter in step 3 of the example of FIG. 1C, Sam employs QR code reading functionality installed on a mobile smartphone 170 and associated with a camera integrated therewith, to scan transaction receipt 166 including QR code 168 into mobile smartphone 170.

In the example of FIG. 1C, information encoded in QR code 168 preferably includes information pertaining to Sam's identity and transaction-derived data relating to Sam's purchase and a reference to a supermarket application associated with supermarket 102 and preferably preinstalled on mobile smartphone 210.

As described hereinabove, it is a particular feature of the present invention that the supermarket application preferably communicates with server 167 and retrieves therefrom virtual customer-personalized content corresponding to promotional offers which are related to Sam's recent purchase. In the example of FIG. 1C, server 167 preferably accesses personal information pertaining to Sam by accessing Sam's personal profile on an internet-based social network, and employs the personal information to generate the virtual customer-personalized content.

It is a particular feature of the present invention that server 167 preferably employs transaction-derived data relating to Sam's purchase to generate virtual customer-personalized content corresponding to promotional offers which are related to Sam's recent purchase. In the example of FIG. 1C, server 167 ascertains that in his recent purchase, Sam has purchased the particular brand of pretzels that he is fond of, as discovered by server 167 by accessing Sam's personal profile on the social network.

As shown in step 4 of the example of FIG. 1C, upon scanning QR code 168 into mobile smartphone 170, the supermarket application is invoked and transmits transaction-derived data relating to Sam's purchase to server 167. Responsive to receiving transaction-derived data relating to Sam's purchase, server 167 transmits virtual customer-personalized content comprising a combined image-textual promotional offer to be displayed on mobile smartphone 170 and addressed to Sam. As further shown in step 4 of FIG. 1C, Sam is prompted to click a button to view the promotional offer.

Thereafter, as shown in step 5 of the example of FIG. 1C, the promotional offer is displayed to Sam on the screen of mobile smartphone 170. As clearly shown, the promotional offer is personalized to match Sam's purchasing pattern, by offering him an item which he purchases frequently, such as the particular brand of pretzels he is fond of, free of charge upon his next purchase. Alternatively the virtual content may be displayed on any other suitable device, which may or may not be a computing device. It is appreciated that the virtual content may also include an interactive feature such as a request for customer feedback or a customer satisfaction survey.

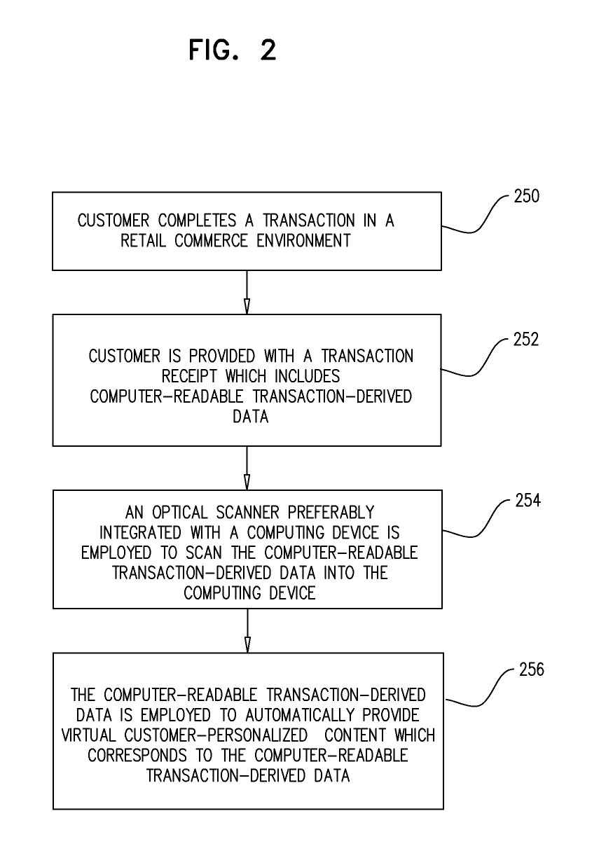

Reference is now made to FIG. 2, which is a simplified flowchart indicating steps in the operation of the system of FIGS. 1A-1C. As described hereinabove, the system of FIGS. 1A-1C is preferably operable for:

enabling a customer to receive a physical transaction-related article comprising at least computer-readable transaction-derived data relating to a transaction of said customer in the retail commerce environment, at least part of the computer-readable transaction-derived data on the physical transaction-related article being scannable, by the customer; and

automatically employing at least part of the computer-readable transaction-derived data to automatically provide, virtual customer-personalized content, preferably augmented reality content, corresponding to at least part of the computer-readable transaction-derived data.

The foregoing functionality may also be understood as:

providing, to a customer, a physical transaction-related article including at least computer-readable transaction-derived data relating to a transaction of the customer in the retail commerce environment;

optically scanning at least part of the computer-readable transaction-derived data; and

automatically employing the at least part of the computer-readable transaction-derived data to automatically provide, to the customer, virtual customer-personalized content corresponding to the at least part of the computer-readable transaction-derived data. Preferably the scanning and the display of the augmented reality content is provided on a single computing device, such as a smart phone, GOOGLE® GLASS™, IPAD® or tablet. Alternatively, the scanning and the display may be on separate devices.

The system is also preferably operable for communicating via the internet and retrieving personal information pertaining to the customer by accessing at least one personal profile of the customer from at least one internet-based social network, and employing the personal information to generate the virtual customer-personalized content. Alternatively or additionally, the system may provide virtual customer-personalized content, for example, text, images, animations, promotional offers and coupons to one or more social networks.

As shown in FIG. 2, a customer initially completes a transaction in a retail commerce environment (250). Upon completing the transaction, the customer is provided with a transaction receipt (252), the transaction receipt preferably including computer-readable transaction-derived data relating to the transaction.

Thereafter, an optical scanner preferably integrated with a computing device is employed to scan the computer-readable transaction-derived data into the computing device (254). The computer-readable transaction-derived data is then employed to automatically provide virtual customer-personalized content which corresponds to the computer-readable transaction-derived data (256). Alternatively the virtual content may be displayed on any other suitable device, which may or may not be a computing device. It is appreciated that the virtual content may also include an interactive feature such as a request for customer feedback or a customer satisfaction survey.

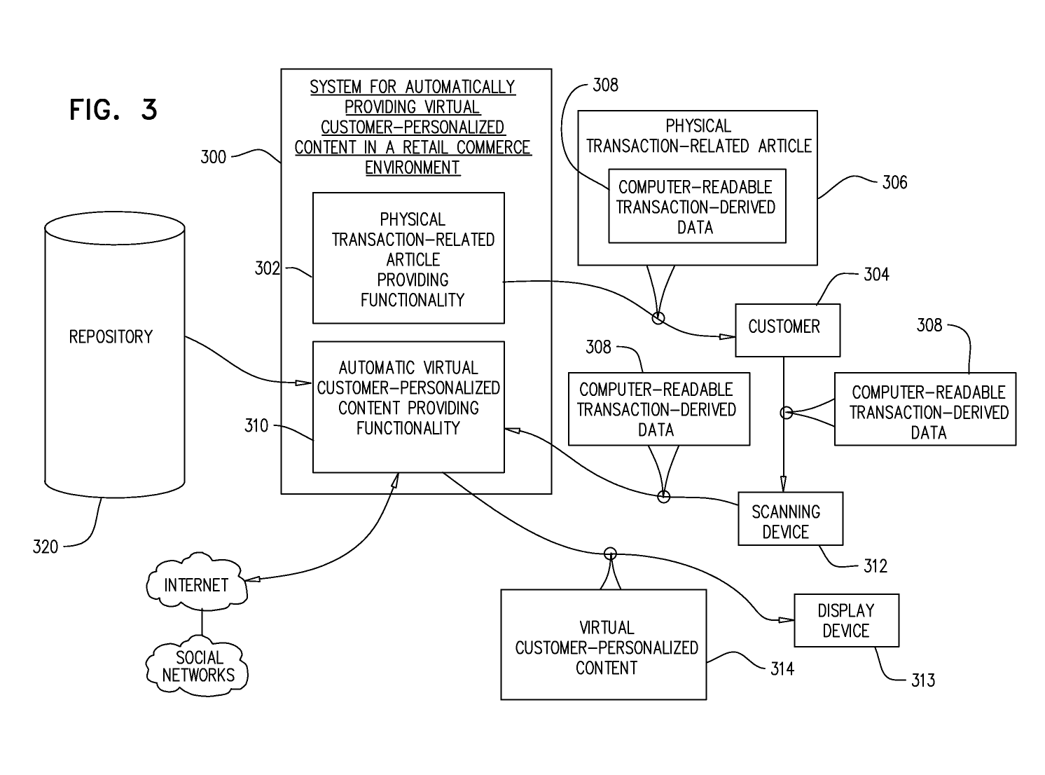

Reference is now made to FIG. 3, which is a simplified block diagram illustration of a system, constructed and operative in accordance with a preferred embodiment of the present invention, for automatically providing virtual customer-personalized content in a retail commerce environment, examples of whose operation are shown in FIGS. 1A-1C.

As shown in FIG. 3, the system 300 for automatically providing virtual customer-personalized content in a retail commerce environment preferably includes physical transaction-related article providing functionality 302 operative to provide, to a customer 304, a physical transaction-related article 306 including at least computer-readable transaction-derived data 308 relating to a transaction of the customer in the retail commerce environment.

System 300 also preferably includes automatic virtual customer-personalized content providing functionality 310 operative, responsive to scanning at least part of computer-readable transaction-derived data 308 by a scanning device 312 communicating with automatic virtual customer-personalized content providing functionality 310, to receive at least part of computer-readable transaction-derived data 308.

Automatic virtual customer-personalized content providing functionality 310 is also preferably operative to automatically employ at least part of computer-readable transaction-derived data 308 to automatically provide, to a display device 313, virtual customer-personalized content 314 corresponding to at least part of computer-readable transaction-derived data 308. It is appreciated that scanning device 312 and display device 313 may be incorporated into a single device, preferably a computing device. Such computing devices may include mobile smartphones, GOOGLE® GLASS™, IPAD®, handheld computing devices and tablet computers including an integrated camera and graphic image processing functionality associated therewith.

Preferably, automatic virtual customer-personalized content providing functionality 310 communicates with a repository 320 which preferably stores and provides access to personal information of customers of the retail environment as well as to information regarding transactions made by customers of the retail environment, and preferably employs the information stored in repository 320 to automatically provide virtual customer-personalized content 314.

The personal information stored in repository 320 may include, for example, names, personal identification numbers and credit card information of customers of the retail environment. Repository 320 may also store information regarding purchasing patterns of customers of the retail environment.

Automatic virtual customer-personalized content providing functionality 310 may also be connected to the internet and may retrieve additional personal information pertaining to customers of the retail environment by accessing personal profiles of customers of the retail environment which are publicly available, for example, on internet-based social networks. Automatic virtual customer-personalized content providing functionality 310 may additionally or alternatively employ this additional personal information to automatically provide virtual customer-personalized content 314. Automatic virtual customer-personalized content providing functionality 310 may analyze information received from the internet to derive conclusions regarding preferences of a customer and to employ those conclusions in preparing the content which is supplied to the customer. Alternatively or additionally, the system may provide virtual customer-personalized content, for example, text, images, animations, promotional offers and coupons to one or more social networks.

Automatic virtual customer-personalized content providing functionality 310 may also be operative to employ personal information, transaction information, preferences and purchasing patterns of customers of the retail environment stored in repository 320 to generate promotional offers, such as coupons, which are customer-personalized. Alternatively, automatic virtual customer-personalized content providing functionality 310 may be operable to access pre-generated promotional offers which are customer-personalized and which are stored in repository 320. Alternatively, automatic virtual customer-personalized content providing functionality 310 is preferably operable to integrate the promotional offers into virtual customer-personalized content 314.

It will be appreciated by persons skilled in the art that the present invention is not limited by what has been particularly shown and described hereinabove. Rather the scope of the present invention includes both combinations and subcombinations of the various features described hereinabove as well as modifications thereof which would occur to persons skilled in the art upon reading the foregoing description and which are not in the prior art.

1. A method for automatically providing virtual customer-personalized content in a retail commerce environment, said method comprising:
enabling a customer to receive a physical transaction-related article comprising at least computer-readable transaction-derived data relating to a transaction of said customer in said retail commerce environment, at least part of said computer-readable transaction-derived data on said physical transaction-related article being scannable, by said customer; and
automatically employing said at least part of said computer-readable transaction-derived data to automatically provide, virtual customer-personalized content corresponding to at least part of said at least part of said computer-readable transaction-derived data.

2. A method for automatically providing virtual customer-personalized content in a retail commerce environment according to claim 1 and also comprising communicating via the internet and retrieving personal information pertaining to said customer by accessing at least one personal profile of said customer from at least one internet-based social network.

3. A method for automatically providing virtual customer-personalized content in a retail commerce environment according to claim 2 and also comprising analyzing and employing said personal information to generate said virtual customer-personalized content.

4. A method for automatically providing virtual customer-personalized content in a retail commerce environment according to claim 1 and wherein said physical transaction-related article is a paper transaction receipt of said transaction.

5. A method for automatically providing virtual customer-personalized content in a retail commerce environment according to claim 1 and wherein said computer-readable transaction-derived data is a QR code comprising at least data related to said transaction.

6. A method for automatically providing virtual customer-personalized content in a retail commerce environment according to claim 1 and wherein said physical transaction-related article is provided by a POS system associated with said retail commerce environment.

7. A method for automatically providing virtual customer-personalized content in a retail commerce environment according to claim 1 and also comprising at least one of:
analyzing transactions made at said retail commerce environment to ascertain customer purchasing patterns of said customer;
retrieving existing customer purchasing pattern information of said customer from a computer network serving said retail commerce environment; and
communicating via the internet and retrieving personal information pertaining to said customer by accessing at least one personal profile of said customer from at least one internet-based social network.

8. A method for automatically providing virtual customer-personalized content in a retail commerce environment according to claim 7 and also comprising at least one of:
analyzing at least some of said personal information;
employing at least some of said personal information, said transaction information and said purchasing patterns of said customer to generate customer-personalized promotional offers; and
retrieving existing customer-personalized promotional offers from a computer network serving said retail commerce environment.

9. A method for automatically providing virtual customer-personalized content in a retail commerce environment according to claim 1 and also comprising displaying said virtual customer-personalized content on a computing device.

10. A method for automatically providing virtual customer-personalized content in a retail commerce environment according to claim 1 and wherein said computing device is one of a handheld computing device and a mobile smartphone.

11. A method for automatically providing virtual customer-personalized content in a retail commerce environment according to claim 1 and wherein said virtual customer-personalized content is overlaid onto said at least part of said computer-readable transaction-derived data scanned into said computing device.

12. A system for automatically providing virtual customer-personalized content in a retail commerce environment, said system comprising:
physical transaction-related article providing functionality operative to provide, to a customer, a physical transaction-related article comprising at least computer-readable transaction-derived data relating to a transaction of said customer in said retail commerce environment;
automatic virtual customer-personalized content providing functionality operative:
responsive to scanning at least part of said computer-readable transaction-derived data communicating with said automatic virtual customer-personalized content providing functionality, to receive said at least part of said computer-readable transaction-derived data; and
to automatically employ said at least part of said computer-readable transaction-derived data to automatically provide, virtual customer-personalized content corresponding to at least part of said at least part of said computer-readable transaction-derived data.

13. A system for automatically providing virtual customer-personalized content in a retail commerce environment according to claim 12 and wherein said automatic virtual customer-personalized content providing functionality is also operable for communicating via the internet and for retrieving personal information pertaining to said customer by accessing at least one personal profile of said customer from at least one internet-based social network.

14. A system for automatically providing virtual customer-personalized content in a retail commerce environment according to claim 13 and wherein said automatic virtual customer-personalized content providing functionality is also operable for at least one of analyzing and employing said personal information to generate said virtual customer-personalized content.

15. A system for automatically providing virtual customer-personalized content in a retail commerce environment according to claim 12 and wherein said physical transaction-related article is a paper transaction receipt of said transaction.

16. A system for automatically providing virtual customer-personalized content in a retail commerce environment according to claim 12 and wherein said computer-readable transaction-derived data is a QR code comprising at least data related to said transaction.

17. A system for automatically providing virtual customer-personalized content in a retail commerce environment according to claim 12 and wherein said physical transaction-related article providing functionality resides on a POS system associated with said retail commerce environment.

18. A system for automatically providing virtual customer-personalized content in a retail commerce environment according to claim 12 and wherein said automatic virtual customer-personalized content providing functionality is also operative to access at least information regarding transactions made by said customer at said retail commerce environment.

19. A system for automatically providing virtual customer-personalized content in a retail commerce environment according to claim 12 and wherein said automatic virtual customer-personalized content providing functionality is also operative to access at least personal information of said customer.

20. A system for automatically providing virtual customer-personalized content in a retail commerce environment according to claim 12 and wherein said automatic virtual customer-personalized content providing functionality is also operable for at least one of:
analyzing transactions made at said retail commerce environment to ascertain customer purchasing patterns of said customer;
retrieving customer purchasing pattern information of said customer from a computer network serving said retail commerce environment; and
communicating via the internet and retrieving personal information pertaining to said customer by accessing at least one personal profile of said customer from at least one internet-based social network.

21. A system for automatically providing virtual customer-personalized content in a retail commerce environment according to claim 20 and wherein said automatic virtual customer-personalized content providing functionality is also operable for at least one of:
analyzing at least some of said personal information;
employing at least some of said personal information, said transaction information and said purchasing patterns of said customer to generate customer-personalized promotional offers; and
retrieving customer-personalized promotional offers from a computer network serving said retail commerce environment.

22. A system for automatically providing virtual customer-personalized content in a retail commerce environment according to claim 12 and wherein said virtual customer-personalized content is displayed on a computing device.

23. A system for automatically providing virtual customer-personalized content in a retail commerce environment according to claim 12 and wherein said computing device is one of a handheld computing device and a mobile smartphone.

24. A system for automatically providing virtual customer-personalized content in a retail commerce environment according to claim 12 and wherein said virtual customer-personalized content is overlaid onto said at least part of said computer-readable transaction-derived data scanned into said computing device.

25. A method for automatically providing virtual customer-personalized content in a retail commerce environment, said method comprising:
providing, to a customer, a physical transaction-related article comprising at least computer-readable transaction-derived data relating to a transaction of said customer in said retail commerce environment;
scanning, by said customer, at least part of said computer-readable transaction-derived data into a computing device; and
automatically employing said at least part of said computer-readable transaction-derived data to automatically provide, to said computing device, virtual customer-personalized content corresponding to at least part of said at least part of said computer-readable transaction-derived data.

26. A system for automatically providing virtual customer-personalized content in a retail commerce environment, said system comprising:
automatic virtual customer-personalized content providing functionality operative:
responsive to scanning computer-readable transaction-derived data provided to a customer into a computing device communicating with said automatic virtual customer-personalized content providing functionality, to receive said at least part of said computer-readable transaction-derived data; and
to automatically employ said computer-readable transaction-derived data to automatically provide, to said computing device, virtual customer-personalized content corresponding to at least part of said computer-readable transaction-derived data.
